(19) United States
(12) Patent Application Publication
(10) Pub. No.: US 2024/0012939 A1
(43) Pub. Date: Jan. 11, 2024

(54) METHOD AND SYSTEM FOR MEDIA REDACTION AT AN EDGE DEVICE

(71) Applicant: IRIS R&D Group Inc., Burlington (CA)

(72) Inventors: Emil Sylvester Ramos, Burlington (CA); David Keaney, Oakville (CA); David Moody, Stoney Creek (CA)

(21) Appl. No.: 18/371,018

(22) Filed: Sep. 21, 2023

Related U.S. Application Data
(63) Continuation of application No. PCT/CA2022/050490, filed on Mar. 31, 2022.
(60) Provisional application No. 63/168,777, filed on Mar. 31, 2021.

(51) Int. Cl. G06F 21/62; G06T 5/00; G06V 10/25

(52) U.S. Cl. CPC G06F 21/6254; G06T 5/002; G06V 10/25

(57) ABSTRACT

Various embodiments are provided herein for a system and method for redaction of media, transportation of redacted media elements and derived metadata and identification, tracking and/or counting of objects within the media. In at least some embodiments provided herein, there is provided a method for redaction at an edge device, the method comprising analyzing media elements received from a media recording unit, identifying image areas for redaction based on predetermined redaction rules, and redacting the identified image areas. In at least some embodiments, metadata is extracted from the media elements prior to redaction and re-embedded within the redacted media element. In at least some embodiments, metadata is transmitted from the edge device separately from the redacted media element.

### CROSS-REFERENCE TO PRIOR APPLICATION

This application is a continuation of International Application Serial No. PCT/CA2022/050490, filed Mar. 31, 2022, which claims the benefit of U.S. Provisional Patent Application Ser. No. 63/168,777, filed Mar. 31, 2021, the entire contents of which are hereby incorporated by reference.

### FIELD

The described embodiments relate generally to a system and method for media redaction, and specifically to a method and system for media redaction, transporting metadata, and various use cases for identification, tracking and/or counting of objects at an edge device.

### INTRODUCTION

Recording of media (i.e., photographs, video clips, image bursts) is a useful tool for monitoring environments, as well as collection of measurements and object data. To name a few examples, media recordings can be used by municipalities tracking pedestrian numbers in a given space, traffic updates, informational data on number of people using a service, and finding stolen items, to name a few.

One challenge with the collection of object data using media lies in the need for privacy in conjunction with the collection and use of measurement data. Another challenge is the transmission of object data in such a way where reintegration into the original video is simplified.

### SUMMARY OF VARIOUS EMBODIMENTS

In a first aspect, there is provided a redaction system, the system comprising an edge device comprising at least one media recording unit and a processor, the at least one media recording unit being configured to record media elements. The processor is configured to receive a media element from the at least one media recording unit, analyze, in real-time, the media element to identify one or more image areas requiring redaction, wherein the image areas requiring redaction are identified based on one or more predetermined classification factors, and redact, in real-time, the identified image areas from the media element to create a redacted media element with redacted image areas.

In one or more embodiments, the processor is further configured to, prior to redaction, extract metadata from the determined image areas, the metadata comprising informational data based on the predetermined classification factors.

In one or more embodiments, the processor is further configured to, after redaction, embed the derived metadata into the corresponding media element.

In one or more embodiments, the processor is further configured to transmit the redacted media element to an external device.

In one or more embodiments, the processor is further configured to transmit the redacted media element and the derived metadata through separate transport streams.

In one or more embodiments, the processor is further configured to transmit the redacted media element and the derived metadata through a single transport stream.

In one or more embodiments, the processor uses an artificial intelligence algorithm to identify the image areas requiring redaction.

In one or more embodiments, the predetermined classification factors are comprised of inputs from an operator.

In one or more embodiments, the processor is coupled to a memory unit.

In one or more embodiments, the memory unit is configured to store the redacted media element.

In one or more embodiments, the memory unit is configured to store the redacted media element and the metadata.

In one or more embodiments, each predetermined classification factor is selected from the group consisting of human faces, license plate numbers, and home addresses.

In one or more embodiments, each predetermined classification can consist of any of a recognizable set of objects, for example vehicles, license plate numbers, human faces, home addresses, identification badges, etc.

In a second aspect, there is provided a computer-implemented method of redacting metadata, the method comprising receiving, at a processor of an edge device, a media element from at least one media recording unit, the edge device comprising the at least one media recording unit configured to record media elements. The method further comprises analyzing, in real time at the processor of the edge device, the media element to identify if one or more image areas require redaction, wherein the image areas requiring redaction are identified based on one or more predetermined classification factors, and redacting, in real-time at the processor of the edge device, the identified image areas from the media element to create a redacted media element with redacted image areas.

In one or more embodiments, the method further comprises extracting, at the processor prior to redacting, metadata from the determined image areas, the metadata comprising informational data based on the predetermined classification factors.

In one or more embodiments, the method further comprises embedding, at the processor after redacting, the derived metadata into the corresponding media element.

In one or more embodiments, the method further comprises transmitting, at the processor, the redacted media element to an external device.

In one or more embodiments, the method further comprises transmitting, at the processor, the redacted media element and the derived metadata through separate transport streams.

In one or more embodiments, the method further comprises an artificial intelligence algorithm in use by the processor to identify the image areas requiring redaction.

In one or more embodiments, the processor is coupled to a memory unit.

In one or more embodiments, the method further comprises storing the redacted media element within the memory unit.

In one or more embodiments, the method further comprises storing the redacted media element and the metadata within the memory unit.

In one or more embodiments, each predetermined classification factor is selected from the group consisting of human faces, license plate numbers, and home addresses.

In a third aspect, there is provided a redaction system, the system comprising at least one media recording unit for recording one or more media elements and at least one redaction device, the at least one redaction device being connected to the at least one media recording unit, the at least one redaction device comprising a processing unit and a memory unit. The processing unit is configured to receive a media element from the at least one media recording unit, analyze, in real-time, the media element to identify one or more image areas requiring redaction wherein the image areas requiring redaction are identified based on one or more predetermined classification factors, and redact, in real-time, the identified image areas from the media element to create a redacted media element with redacted image areas.

In one or more embodiments, the processing unit is further configured to extract metadata from the identified image areas prior to redaction to generate derived metadata, the metadata comprising informational data based on the predetermined classification factors.

In one or more embodiments, the processing unit is further configured to, after redaction, embed at least a part of the derived metadata into the corresponding redacted media element to generate a derived media element.

In one or more embodiments, the processing unit is further configured to transmit the redacted media element.

In one or more embodiments, the processing unit is further configured to transmit the redacted media element, the metadata, and the derived media element through separate transport streams.

In one or more embodiments, the processing unit is further configured to transmit the redacted media element, the metadata, and the derived media element through a single transport stream.

In one or more embodiments, the processing unit uses an artificial intelligence algorithm to identify the image areas requiring redaction.

In one or more embodiments, the predetermined classification factors are comprised of inputs from an operator.

In one or more embodiments, the processing unit is coupled to a memory unit.

In one or more embodiments, the memory unit is configured to store the redacted media element.

In one or more embodiments, the memory unit is configured to store the redacted media element and the metadata.

In one or more embodiments, the memory unit is configured to store the redacted media element, the metadata, and the derived media element.

In one or more embodiments, each predetermined classification factor is selected from the group consisting of human faces, license plate numbers, and home addresses.

In a fourth aspect, there is a provided a computer-implemented method of redacting media, the method comprising receiving, at a processing unit of at least one redaction device, a media element from at least one media recording unit, the at least one redaction device being connected to the at least one media recording unit, analyzing, in real-time at the processing unit of the at least one redaction device, the media element to identify if one or more image areas require redaction, wherein the image areas requiring redaction are identified based on one or more predetermined classification factors, and redacting, in real-time at the processing unit of the at least one redaction device, the identified image areas from the media element to create a redacted media element with redacted image areas.

In one or more embodiments, the method further comprises, at the processing unit, extracting metadata from the identified image areas prior to redaction to generate derived metadata, the metadata comprising informational data based on the predetermined classification factors.

In one or more embodiments, the method further comprises, at the processing unit, embedding at least part of the derived metadata into the corresponding redacted media element after redaction to generate a derived media element.

In one or more embodiments, the method further comprises transmitting, at the processing unit, the redacted media element.

In one or more embodiments, the method further comprises transmitting, at the processing unit, the redacted media element, the metadata, and the derived media element through separate transport streams.

In one or more embodiments, the method further comprises transmitting, at the processing unit, the redacted media element, the metadata and the derived media element through a single transport stream.

In one or more embodiments, the method further comprises an artificial intelligence algorithm in use by the processor to determine the image areas requiring redaction.

In one or more embodiments, the processing unit is coupled to a memory unit.

In one or more embodiments, wherein the method further comprises storing the redacted media element within the memory unit.

In one or more embodiments, the method further comprises storing the redacted media element and the metadata within the memory unit.

In one or more embodiments, the method further comprises storing the redacted media element, the metadata, and the derived media element within the memory unit.

In one or more embodiments, each predetermined classification factor is selected from the group consisting of human faces, license plate numbers, and home addresses.

### BRIEF DESCRIPTION OF THE DRAWINGS

A preferred embodiment of the present invention will now be described in detail with reference to the drawings, in which:

FIG. 1A is a simplified block diagram of an example embodiment of a system for media redaction at an edge device, in accordance with some embodiments;

FIG. 1B is a simplified block diagram of an example embodiment of a system for media redaction at an edge device, in accordance with other embodiments;

FIG. 2A is a simplified block diagram of an example embodiment of an edge device, in accordance with some embodiments;

FIG. 2B is a simplified block diagram of an example embodiment of an edge device, in accordance with other embodiments;

FIG. 2C is a simplified block diagram of an example embodiment for a computing device;

FIG. 3A is a simplified block diagram of an example embodiment of a redaction process, in accordance with some embodiments;

FIG. 3B is a simplified block diagram of an example embodiment of a redaction process, in accordance with some other embodiments;

FIG. 3C is a simplified block diagram of an example embodiment of a redaction process, in accordance with still some other embodiments;

FIG. 4A is an example embodiment of a method for redaction at an edge device in accordance with some embodiments;

FIG. 4B is an example embodiment of a method for redaction at an edge device in accordance with some other embodiments;

FIG. 4C is an example embodiment for a method for redaction at an edge device in accordance with still some other embodiments;

FIG. 4D is an example embodiment for a method for redaction at an edge device in accordance with still some other embodiments;

FIG. 4E is an example embodiment for a method for redaction at an edge device in accordance with still some other embodiments;

FIG. 4F is an example embodiment for a method for redaction at an edge device in accordance with still some other embodiments;

FIG. 5A is an exemplary image before redaction in accordance with some embodiments;

FIG. 5B is an exemplary image after redaction in accordance with some embodiments;

FIG. 6A is an exemplary image before redaction in accordance with some embodiments;

FIG. 6B is an exemplary image after redaction in accordance with some embodiments;

FIG. 7 is an exemplary image after derived metadata is embedded within the media element in accordance with some embodiments;

FIG. 8 is another exemplary image after derived metadata is embedded within the media element in accordance with some embodiments;

FIG. 9 is an exemplary image after derived metadata is embedded within the media element in accordance with some other embodiments;

FIG. 10A is an exemplary image after derived metadata is embedded within the media element in accordance with some other embodiments; and

FIG. 10B is an exemplary image after derived metadata is embedded within the media element in accordance with some other embodiments.

### DESCRIPTION OF EXEMPLARY EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicant(s), inventor(s) or owner(s) do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the example embodiments described herein.

It should also be noted that the terms “coupled” or “coupling” as used herein can have several different meanings depending in the context in which these terms are used. For example, the terms coupled or coupling can have a mechanical, chemical or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as edge devices and redaction devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

It should also be noted that there may be some elements that are used to implement at least part of the embodiments described herein that may be implemented via software that is written in a high-level procedural language such as object-oriented programming. The program code may be written in JAVA, C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media (e.g., a computer readable medium such as, but not limited to, ROM, flash memory, magnetic disk, optical disc) or a device that is readable by a programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, DVD, tapes, chips, and magnetic, optical and electronic storage. In at least one alternative embodiment, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

In some embodiments, the communication interface may be a network communication interface. In embodiments in which elements are combined, the communication interface may be a software communication interface, such as those for inter-process communication (IPC). In still other embodiments, there may be a combination of communication interfaces implemented such as hardware, software, and combinations thereof.

As explained in the background discussion, observation and surveillance are often necessary in public places for safety, informational, or research related purposes. Businesses and research facilities often rely on media elements to conduct safety checks or collect data. These media elements may, however, contain identifying data on people or vehicles.

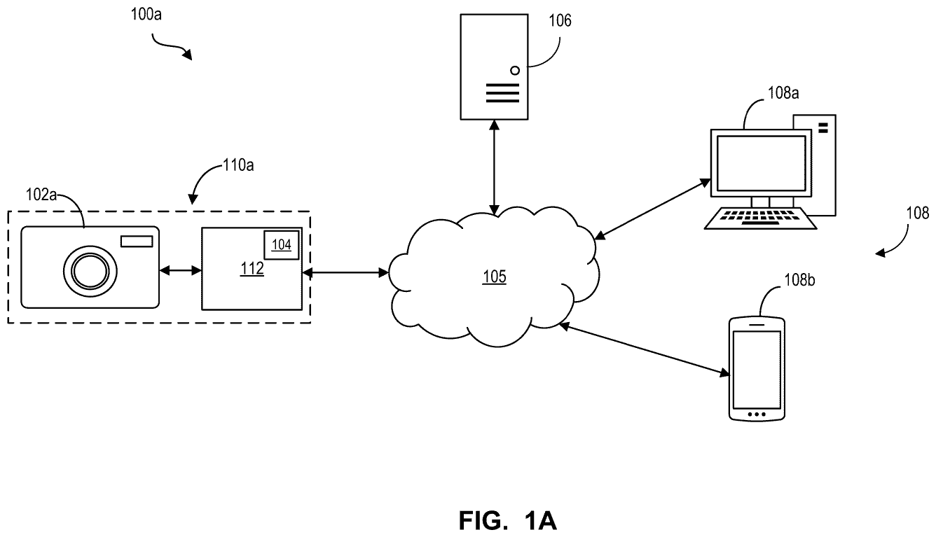

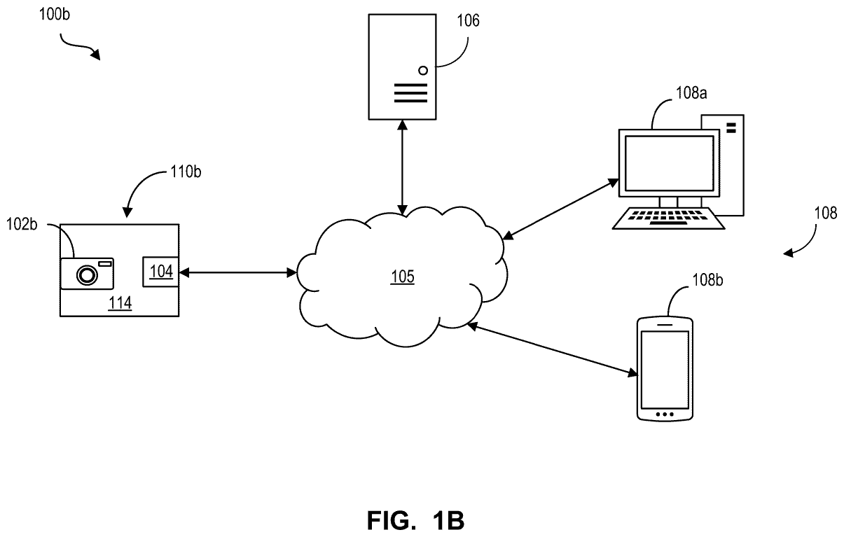

Reference is first made to FIG. 1A, which illustrates a simplified block diagram of an example embodiment of a system 100a for redaction at an edge device.

As shown, the redaction system 100a generally includes a media recording unit 102a, a redaction device 112, a server 106 and one or more computer terminals 108a, 108b.

The media recording unit 102a may be configured to capture various types of media elements including, for example, video, images, image bursts, and/or audio media. Captured video can comprise a plurality of captured image frames that are captured at any pre-determined and/or variable frame rate. In various cases, the media recording unit 102a can be a camera (i.e., a digital camera, a closed-circuit television camera, etc.).

Other examples of media recording unit 102a can include traffic cameras, body cams, smart building security cameras and other security cameras etc. In some cases, the media recording units 102a consist of Internet of Things or IoT sensors or devices.

In the illustrated embodiment, the media recording unit 102a is coupled to the redaction device 112. For example, the redaction device 112 may be connected to the media recording unit 102a through a direct secure connection (e.g., a wired USB or HDMII connection). In another example, the redaction device 112 can be conveniently and directly coupled to “off the shelf” camera systems using standardized connections (i.e., a “plug-and-play” device). In a further example, the redaction device 112 is directly or indirectly coupled to the media recording unit 102a using a secure network, including for example, network 105.

In some cases, the redaction device 112 is a physical component (e.g. a physical server or processor etc.). In some other cases, the redaction device 112 is a virtualized component (e.g. a cloud device).

The redaction device 112 includes a media redaction module 104. The media redaction module 104 is configured to receive media elements captured by the media recording unit 102a, and may be configured to redact certain target areas of these media elements to generate redacted media elements (i.e., modifying the media element to generate a redacted media elements). As explained, the redacted media elements may be transmitted, over the network 105, to one or more of the server 106 and/or the computer terminals 108.

In some cases, redaction by the redaction module 104 can occur in real-time or near real-time. For example, the redaction module 104 may receive real-time or near real-time media elements from the media recording unit 102a. The media elements can then be processed, in real-time or near real-time, to generate one or more of redacted media elements. The redacted media elements may then be transmitted to other components connected to the network 105.

The combination of the media recording unit 102a and the redaction device 112, may be referred to as an “edge device” 110a— in other words, a device located on the edge of the network 105. The edge device 110a therefore allows redaction such that only redacted media elements can exit the edge device 110a through the network 105. This can accordingly prevent non-redacted, and privacy sensitive media elements from being transmitted over the network 105 to other computing devices 108 and/or server 106, which can risk the unredacted media being intercepted during transmission by, for example, unscrupulous third parties. Accordingly, embodiments provided herein allow for secure redaction “on the spot” (i.e., at the edge device). This is contrasted to many prior systems where the redaction occurs on a remote, unsecure, third party computing device and therefore presents the risk that the unredacted media elements can be intercepted, and the privacy sensitive information contained therein being possibly used for nefarious purposes.

To this end, in various embodiments, the edge device 110a may be a secure element which prevents unauthorized access, but otherwise allows authorized access. Accordingly, unauthorized personnel may not breach the edge device 110a to acquire the unredacted media elements. In other embodiments, the edge device 110 may be secured to prevent any type of access.

In some cases, one or more of the edge devices 110a, 110b are located at a local 5G node. In some other cases, where the media recording unit 102a and the redaction device 112 are not incorporated into a same hardware or a same physical encapsulation, the redaction device 112 may be located at a local 5G node. In such cases, the media recording units 102a may be coupled (e.g. connected, tethered or wireless connected, or otherwise directly or indirectly coupled etc.) to the 5G network. In such cases, the redaction device 112 may transmit some or all of the redacted media elements, derived metadata and derived redacted media elements, as discussed in detail below, using the 5G network.

In some embodiments, the media redaction module 104 generates the redacted media elements by identifying target redaction areas in the media elements that are required to be redacted. For example, this can include identifying target areas of captured images, or target areas of captured image frames of a digital video. An area can include, for example, one or more contiguous or non-contiguous image pixels.

As explained, the target redaction areas can be identified by the media redaction module 104 based on one or more predetermined redaction rules. The redaction rules generally include conditions for determining when an area of a media element (for example, an area of an image or a video frame) requires redaction.

In some cases, the redaction rules can include determining whether an area of a media element includes privacy sensitive subject matter. For instance, and by way of non-limiting examples, redaction rules can include determining whether an area includes human faces, entire human subjects, license plates, any type of sensitive text (e.g., an address), and/or objects on private property. In other cases, the redaction rules can also include determining, more generally, whether an area of a media element includes non-desirable subject matter, irrespective of whether that subject matter is privacy sensitive. For instance, the redaction rule can include determining that an area of a media element includes target moving objects, target airborne objects, shadow artifacts or other undesirable lighting effects.

In some embodiments, as provided, prior to the privacy redaction module 104 generating the redacted media elements, the module 104 may extract metadata from target redaction areas to generate derived metadata. The derived metadata may include informational data on the subject matter contained in the redaction areas. For example, if the target redaction areas include human subjects, the derived metadata may include, by way of non-limiting examples, identifying information on the height, sex, skin color, hair color, approximate weight, and/or facial features of the subject located within the media element. In other embodiments, the derived metadata may include information corresponding to the location of the image area within the media element where the redacted subject is located.

By generating the derived metadata, a party receiving the redacted media elements can also receive information about the redacted elements. This information can then be advantageously used by the third parties to generate insights or monitor statistics (e.g., number of subjects, or number of males versus females that have accessed a space such as a washroom or swimming pool, etc.), without comprising the privacy of the objects or people being redacted. Accordingly, a wide range of third parties may be able to access redacted media captured of an environment, as well metadata about that media (i.e., for analysis) without compromising privacy concerns.

In some embodiments, the derived metadata, which is extracted from the media elements, can be transmitted as a separate data stream from the redacted media element. In these cases, the derived metadata can be transmitted as an encrypted stream to prevent exposure of the information contained in the derived metadata during transmission. In some embodiments, some or all of the derived metadata can be transmitted as an unencrypted stream.

In other embodiments provided, the derived metadata can be directly embedded into the corresponding redacted media elements to generate derived redacted media elements. A derived redacted media element includes the redacted media element, as well as embedded derived metadata extracted from the redacted areas. This, in turn, allows for transmitting a single data stream from the edge device 110a which includes both the redacted media elements and any corresponding derived metadata. In various cases, this can ensure that the derived metadata is not lost during transmission, and is integrated within the redacted media elements. This can also avoid any synchronization problems in respect of correlating derived metadata with its corresponding redacted media element as may be the case when transmitting the derived metadata and the redacted media element in two separate streams.

In various embodiments, one or more of the various data streams, such as, for example, redacted media element, derived metadata and/or derived redacted media elements are encrypted using an encryption protocol, such as, for example, a Transport Layer Security (TLS) 1.2 protocol or above, etc. In some other cases, one or more of the various data streams may be encrypted using a Secure Sockets Layer (SSL) encryption protocol, such as SSL 2.0 or 3.0. In some further cases, one or more of the various data streams may be encrypted using TLS 1.0 or 1.1 protocols.

In some embodiments, the various data streams may be encrypted using one or more of the SSL or TLS or other cryptographic protocols upon generation of such streams, and prior to transmission. In some other embodiments, the various data streams may be encrypted using one or more of the SSL or TLS or other cryptographic protocols at the time of transmission of such streams over the network. In some embodiments, different encryption protocols may be used upon generation and during transmission over the network. For example, a first encryption protocol may be used upon generation of one or more of redacted media element, derived metadata and/or derived redacted media elements, and a second encryption protocol (i.e. such streams may be further encrypted, or decrypted and re-encrypted) may be applied during transmission of such streams over the network.

In some cases, the derived metadata can be broken down into time steps to avoid issues arising from compression. In other words, the derived metadata is not updated on every frame when embedded into redacted media elements to generate derived redacted media elements. This may provide the advantage of successfully transmitting useful metadata without losing some or all of it to compression losses. For example, as is typically the case with video, the derived redacted media elements are compressed before transmission. In such cases, the derived metadata is also compressed along with the redacted media elements, which can cause the metadata to be unusable. With the derived metadata broken down into time steps or, in other words, the derived metadata staying the same over a number of frames and only being updated at some frequent gaps, the compressed derived redacted media elements can have enough frames to capture the derived metadata containing portions of the media element. The frequency of updates required to the embedded derived metadata can be determined based on the frequency of change in the original media elements being redacted. For example, in cases, where the frequency of change (in human subjects or other objects etc.) in a frame or a media element to be redacted is low, the embedded derived metadata may not be updated as frequently as compared to when the frequency of change is high. In such cases, interpolation and other similar techniques can be used to determine the change in redacted metadata in the intervening frames.

For example, the derived redacted media element can show a subject walking across the screen. The derived metadata for the subject can stay the same in the derived redacted media element for any predetermined period of time or number of frames (e.g., 0.5 second, 1 second, 1.5 seconds, etc., or over 2 frames, 4 frames, 8 frames etc.). In such cases, interpolation techniques can be used to determine the subject's movement and position in the intervening media frames.

The same discussion as above applies to the redacted media elements, such that the redacted media elements may remain the same over a predetermined period of time or number of frames to prevent compression losses. Instead, interpolation or similar techniques can be used to determine the changes in the redacted media elements over the intervening frames.

In cases where the derived metadata is embedded into the redacted media element, the derived metadata can be embedded in an encrypted manner. When the derived metadata is received at a receiving computing device (e.g., devices 108a,b etc.), it may then be decoded to extract the information contained in the derived metadata.

Referring still to FIG. 1A, network 105 may be connected to the internet. Typically, the connection between network 105 and the Internet may be made via a firewall server (not shown). In some cases, there may be multiple links or firewalls, or both, between network 105 and the Internet. In some cases, multiple networks 105 or virtual networks 105 may be operated, which can be internetworked or isolated. These have been omitted for ease of illustration, however it will be understood that the teachings herein can be applied to such systems. Network 105 may be constructed from one or more computer network technologies, such as IEEE 802.3 (Ethernet), IEEE 802.11 and similar technologies, and can be wired or wireless. In various cases, network 105 may be a WiFi® or cellular network. In some other cases, network 105 may be any network or network components capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), 4G/5G networks, Worldwide Interoperability for Microwave Access (WiMAX), etc.), and others, including any combination of these.

Server 106 is a computer server that is connected to network 105. Server 106 has a processor, volatile and non-volatile memory, at least one network interface, and may have various other input/output devices. As with all devices shown in the system 100a, there may be multiple servers 106, although not all are shown. It will also be understood that the server 106 need not be a dedicated physical computer. For example, in various embodiments, the various logical components that are shown as being provided on server 106 may be hosted by a third party “cloud” hosting service such as Amazon™ Web Services™ Elastic Compute Cloud (Amazon EC2).

In embodiments provided, the server 106 may communicate with the edge device 110a to receive one or more of redacted media elements, derived metadata and/or derived redacted media elements. In some cases, the server 106 may receive this data and store this data for subsequent access by one or more computing devices 108. In other cases, the server 106 may transmit the redacted media elements, derived metadata and/or derived redacted media elements (i.e., in real-time, or near real-time), to one or more computing devices 108. In some other embodiments, the server 106 may store one or more software programs that are operable to process the received data (i.e., redacted media elements, derived metadata and/or derived media elements), to generate further processed data.

In some cases, where the server 106 is a “cloud server”, communication between the edge device 110a and the cloud server 106 may allow the edge device 110a to act as part of the Internet of Thing (“IoT”) (i.e., an IoT edge device).

Computing device 108 may be any suitable computing devices associated with third parties, such as a desktop computer, and may also include mobile devices such as smartphones, tablets or laptops. In various cases, the computing devices 108 can receive the redacted media elements and derived metadata, and analyze the redacted media elements and derived metadata for further processing (i.e., monitoring the number of individuals, or types of individuals, to access a particular space over time based on the derived metadata). In other cases, the computing devices 108 may be used analyze derived redacted metadata for the same.

Reference is now made to FIG. 1B, which illustrates a simplified block diagram of an example embodiment of a system 100b for privacy at an edge device.

The system 100b is generally analogous to the system 100a, with the exception that the edge device 110b comprises a single physical (e.g. a hardware unit) or virtualized unit 114, which includes both a media capturing unit 102b and the privacy redaction module 104. Accordingly, the unit 114 may be a specially adapted unit that is configured to carry out both functions of capturing media elements, and preforming redaction on the captured media elements.

In some cases, the edge devices 110a, 110b are physical components (e.g. a physical server, hardware or processor etc.). In some other cases, the edge devices 110a, 110b are virtualized components (e.g. a cloud device).

In some cases, the edge device, such as the edge device 110b, receives one or more audio/video streams on one or more wired or wireless connections. In such cases, the edge device 110b processes the received audio/video streams, redacting and transmitting the redacted streams to a server 106 or a computing device 108 or another third party for further processing and insight generation. In various cases, the redaction is done in real-time or near real-time. In various cases, the redaction and transmission are both done in real-time or near real-time.

In some cases, the edge device, such as the edge device 110a, is an IoT device and configured to receive one or more audio/video streams on one or more wired or wireless connections. In such cases, the incoming streams are processed on the cloud or a virtualized server, generating redacted streams, derived metadata streams and/or derived redacted streams in real-time or near real-time.

While only a single edge device 110a, 110b has been illustrated in FIGS. 1A and 1B, any number of edge devices 110 may be located in the systems 100 and may be operating at any given time (i.e., concurrently or at separate times), and/or may be collecting media elements of the same or different locations at the same or different times. The edge devices can be any combination of the edge devices 100a or 100b.

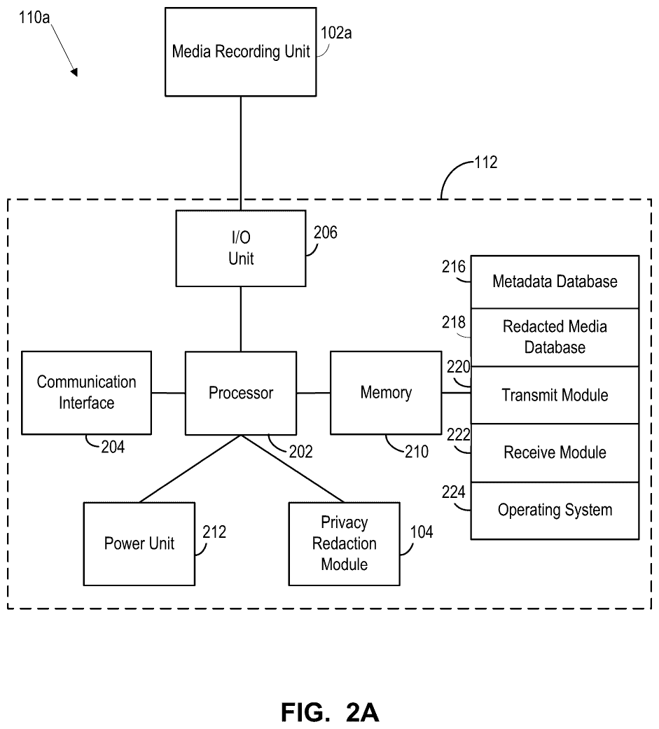

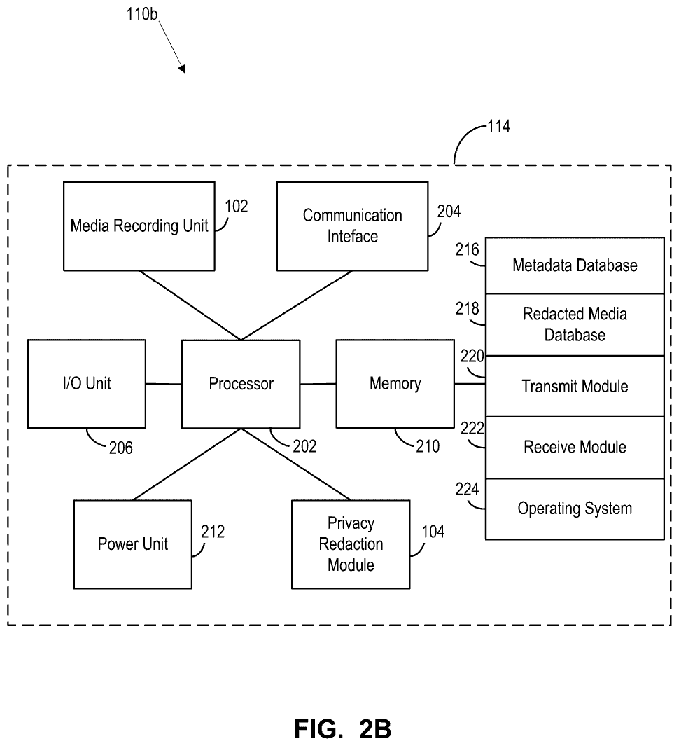

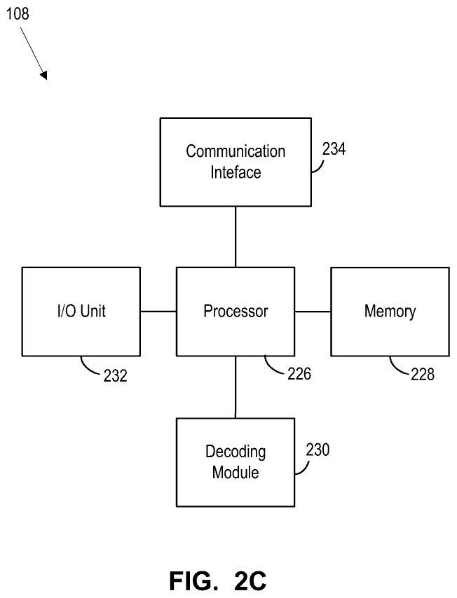

Referring now to FIG. 2A, which shows a simplified block diagram of an example embodiment of an edge device, such as, for example, edge device 110a of FIG. 1A.

As shown, the edge device 110a may generally include the media recording unit 102 which is connected (i.e., via wired secure connection) to the redaction device 112. The redaction device 112 includes a processor 208 and the redaction module 104. In some embodiments, the processor 202 may also couple to one or more of a communication interface 204, an I/O unit 206, a memory 210, a power unit 212, or any combination of the aforementioned units.

Processor 202 can be any suitable processor, controller or digital signal processor that can provide sufficient processing power depending on the configuration, purposes and requirements of the edge device 110a as is known by those skilled in the art. For example, the processor 202 may be a high-performance general processor. In alternative embodiments, the processor 202 can include more than one processor with each processor being configured to perform different dedicated tasks. In alternative embodiments, it may be possible to use specialized hardware to provide some of the functions provided by the processor 202. For example, the processor 202 may include a standard processor, such as an Intel® processor, an ARM® processor or a microcontroller.

Communication interface 204 can include wired or wireless connection capabilities. The communication interface 204 can include a radio that communicates utilizing 4G, LTE, 5G, CDMA, GSM, GPRS or Bluetooth protocol according to standards such as IEEE 802.11a, 802.11b, 802.11g, or 802.11n, etc. The communication interface 204 can be used by the redaction device 112 to communicate with other devices or computers via the network 105 of FIG. 1A.

I/O unit 206 can include at least one of a mouse, a keyboard, a touch screen, a thumbwheel, a track-pad, a track-ball, a card-reader, voice recognition software and the like depending on the particular implementation of the redaction device 112. In some cases, some of these components can be integrated with one another. In various cases, the media recording unit 102a may couple to the redaction device 112, via the I/O unit 206.

Power unit 212 can be any suitable power source that provides power to the redaction device 112 (and in some cases, the media recording unit 102a) such as a power adaptor or a rechargeable battery pack depending on the implementation of the redaction device 112 as is known by those skilled in the art.

Privacy redaction module 104 may be used to identify target areas (i.e., one or more contiguous or non-contiguous pixel areas) of a media element to redact, and to further redact these target areas. The redaction can occur by using any suitable redaction technique, including using a blur, mask, remove, ghost, or cover for any sensitive content present within a received media element, or otherwise content that is not desired to be viewable. As explained previously, the privacy redaction module 104 may be configured to redact faces, people entirely, license plates, addresses, text, moving objects, shadows, passports, objects with personal identifiers, objects on public property, objects on private property, airborne objects, or other lighting effects. The privacy redaction module 104 can also extract derived metadata from media elements, as well as embed the derived metadata into the media elements to generate derived redacted media elements.

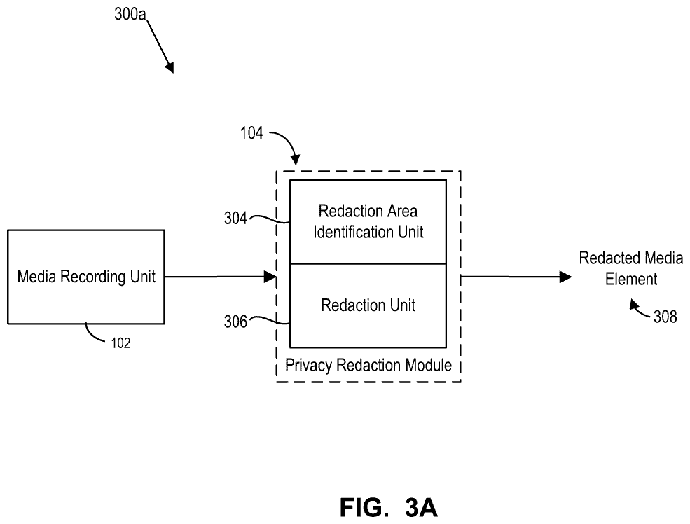

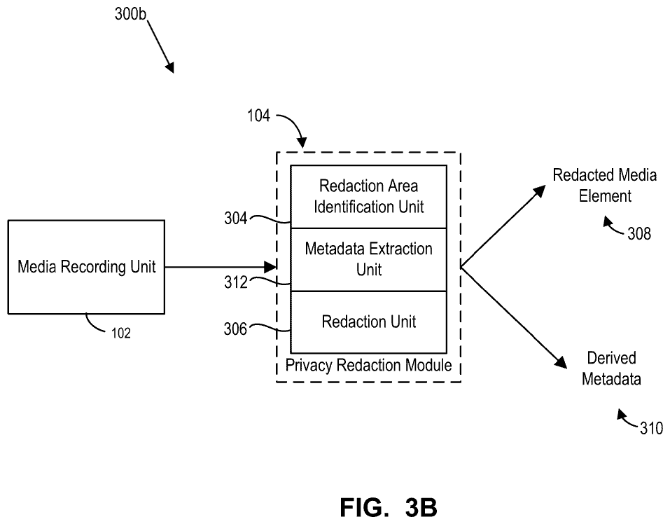

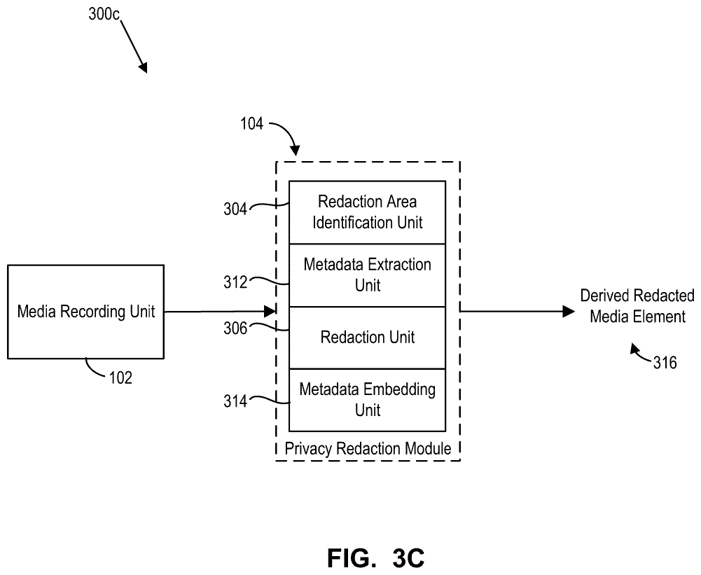

Privacy redaction module 104 may further comprise an artificial intelligence (AI) algorithm. The AI algorithm may be implemented by dedicated hardware, GPU hardware, as an FPGA, as part of a special function on a System on a Chip (“SoC”), or any combination of the aforementioned implementations. The AI algorithm may be used to identify image areas requiring redaction, as further described in FIG. 3.

Memory 210 may include both a volatile and non-volatile memory. Non-volatile memory stores computer programs consisting of computer-executable instructions, which may be loaded into volatile memory for execution by processor 202 as needed. It will be understood by those skilled in the art that reference herein to the edge device 110a as carrying out a function, or acting in a particular way, imply that processor 202 is executing instructions (e.g., a software program) stored in memory 210 and possibly transmitting or receiving input data and output data via one or more interfaces. Memory 210 may also store input data to, or output data from, processor 202 in the course of executing the computer-executable instructions.

In some embodiments, the memory 210 may store the privacy redaction module 104. That is, while the memory 210 and the privacy redaction module 104 have been illustrated separately for ease of exposition, the privacy redaction module 104 may comprise one or more executable instructions (i.e., software program) stored in the memory 210.

Memory 210 may also store software code for implementing a metadata database 216, a redacted media database 218, a transmit module 220, a receive module 222, and an operating system 224. The memory unit 210 can include RAM, ROM, one or more hard drives, one or more flash drives or some other suitable data storage elements such as disk drives, etc.

In some embodiments, the memory 210 is configured to store one or more of the incoming media elements from one or more of the media recording unit, as well as the generated redacted media elements, derived metadata and/or the derived redacted media elements (discussed in detail below). In some embodiments, the one or more of the incoming media elements, redacted media elements, derived metadata and/or the derived redacted media elements are cached in the memory 210. The cache may be cleared upon a predetermined duration of time in some cases. In some other cases, the cache may be cleared once the redacted media elements, derived metadata and/or the derived redacted media elements are transmitted from the edge device 110 over the network.

Metadata database 216 may be configured to store information, such as information taken from the redacted image areas within media elements (i.e., derived metadata), or otherwise information related to the media elements in the redaction system.

Redacted media database 218 may be configured to store previously redacted media elements.

Transmit module 220 is configured to, in collaboration with other components of the edge device 110a, configure and transmit (i.e., via the communication interface 204) data signals (or data streams) for transmittal. For example, the transmit module 220 encodes the device's data into a data signal and transmits the data signal. The data signals can include one or more of redacted media elements, derived metadata and/or derived media elements. The data signals may be transmitted over network 105.

Receive module 222 is configured to receive one or more information signals from one or more other devices (i.e., via the communication interface 204). The receive module 222, in collaboration with other components of the edge device 200, may be configured to receive media elements from at least one media recording unit.

Operating system 224 provides various basic operational processes for the operation of the edge device 110a. For example, the operating system 224 may be a Microsoft® Windows Server® operating system, or a Linux®-based operating system, Unix® or macOS®, or another operating system.

Referring now to FIG. 2B, which shows a simplified block diagrams of an example embodiment of the edge device 110b of FIG. 1B.

The edge device 110b is generally analogous to the edge device 110a, with the exception that the media recording unit 102 is located within the same hardware block as the remaining components (i.e., 104, 202-224). In these cases, the media recording unit 102 may be directly coupled to the processor 202 (or may be indirectly coupled as well).

Referring now to FIG. 2C, which shows a simplified block diagrams of an example embodiment of a computing device 108.

As shown, similar to the edge devices 110, the computing device 108 may also include a processor 226 coupled to a memory 228 and one or more of a decoding unit 230, I/O unit 222 and a communication interface 234.

As explained, the decoding unit 230 can be used to decode (i.e., de-encrypt) received derived metadata that is received from an edge device 110 and/or server 106. The decoding unit 230 can also be used to extract and decode (i.e., de-encrypt) derived metadata that is embedded in a derived redacted media element.

Although illustrated separately from the memory 228, the decoding module 230 may be a software module that is stored on the memory 228 and executed by the processor 226.

In various cases, the server 106 may have a similar hardware and software architecture as the computing device 108.

Referring now to FIG. 3A, there is shown a simplified block diagram of an example embodiment of a privacy redaction process 300a in accordance with some embodiments.

As shown, a media recording unit 102 may transmit an incoming stream to the privacy redaction module 104. In some embodiments, the privacy redaction module 104 may include a redaction area identification unit 304 and a redaction unit 306.

Redaction area identification unit 304 may be configured to receive one or more media elements from the media recording unit 102, and identify target redaction areas based on one or more redaction rules. The redaction rules can classify areas of the media elements that require redaction, and can comprise, for example, groups of contiguous or non-contiguous pixels in a media elements. As described above, the redaction rules may include, for example, determining the presence in media elements of faces, people entirely, license plates, addresses, text, moving objects, shadows, passports, objects with personal identifiers, objects on public property, objects on private property, airborne objects, or other lighting effects.

The redaction rules used by a given privacy redaction module 104 may vary based on various redaction configuration settings. For instance, an example redaction setting can be the environment in which the media recording unit 102 is located. That is, the redaction rules may vary based on the surrounding environment. For example, where the edge device 110 is located in a washroom or a bathroom setting, the redaction rules may involve marking areas for redaction in media elements that correspond to human subjects. That is, in washroom or bathroom settings the redaction rules can specifically target human subjects to preserve their privacy in the washroom or bathroom setting. A similar idea may be followed in the case of deploying the edge device 110 in a swimming pool area. In other cases, where the edge device 110 is located on a street way (or pedestrian area), the redaction rules may involve not only identifying the presence of subjects, but also identifying for redaction areas where license plates are identified in the media elements, or objects located on private property.

The redaction rules may also vary based on other redaction settings that include the time of day. For example, certain objects can be redacted at different times of the day (e.g., cars versus people, etc.), as for example if an area is repurposed during the course of a day. The time of day can be monitored, for example, based on an internal clock in the edge device 110 (not shown), or one or more ambient light sensors (i.e., detect dark versus light conditions), or an external source of ‘time of day’ information (not shown).

In still other cases, the redaction rules may vary based on the area of the media element being analyzed. That is, within a given media element, some portions of the media element may have different redaction rules than other portions of the media element. For example, if the media element corresponds to an image of a room, different parts of the rooms may have different redaction rules. For example, if a camera is monitoring a room that includes one or more cloth changing stalls that are viewable by the camera, it may be desirable to implement unique redaction rules for the known areas of the media element which correspond to the imaged locations of the changing stalls. Accordingly, if a customer enters a changing stall, the redaction rules may be automatically applied to preserve the privacy of that individual while they are changing. However, once the individual exists the changing stall and enters an imaged area outside of the changing stalls, the same redaction rules may no longer apply. In this manner, another redaction setting is the area (or portion) of the media element being analyzed. In still other cases, the area of a media element that is subject to the redaction rules may vary based on factors including, the time of day or the location of the edge device 110.

In some embodiments, the redaction rules and/or redaction configuration settings may be pre-set (or pre-defined). For example, during an initialization stage, an operator may interact with the edge device 110 to configure the redaction settings, as well as the redaction rules associated with that setting. For example, the operator may stipulate a redaction rule that any detected human subjects should be redacted, but may qualify this rule with a setting that the redaction rule only applies between 8 AM to 5 PM, or only to particular regions of a media element. The operator may also initialize these rules and settings for an edge device 110 having regard, for example, to the environment in which the edge device 110 is located. In some cases, the modification of the redaction rules and/or settings may occur directly by interacting with the I/O unit 206 of each edge device 110. In other cases, the redaction rules and/or settings can be modified remotely (i.e., via a computing terminal 108 communicating via the network 105).

In some cases, as in the embodiment of FIG. 1A, a privacy redaction hardware unit 114 may also be coupled to multiple media recording units 102. In these cases, the privacy redaction module 104 can store different redaction profiles (i.e., redaction rules and/or redaction settings) for different media recording units 102.

Once the redaction identification unit 304 has identified one or more target areas (e.g., pixel areas) for redaction, the identification unit 304 may generate an indication of the target areas for redaction. For example, the identification unit 304 may generate pixel coordinate data defining the area of the media element requiring redaction. For example, these can include coordinate data for one or more corners of an imaginary bounding box around the target area (i.e., or any other shape of bounding box). In other cases, the output of the identification unit 304 is a media element comprising one or more marked visual indications of the target redaction areas (i.e., a lined bounding box around the area).

To identify target redaction areas, the identification unit 304 may be operable to perform image analysis on the received media elements. For example, the identification unit 304 may include a trained image analysis machine learning model. The trained machine learning model may be configured to analyze the media to locate specific areas (e.g., pixel groups) that satisfy certain redaction rules and/or settings. For example, the trained machine learning model may be trained to identify human faces, license plates, specific classes of objects, etc. as the case may be. In various embodiments provided, the trained machine learning model is a trained convolution neural network (CNN) configured to perform classification of image areas.

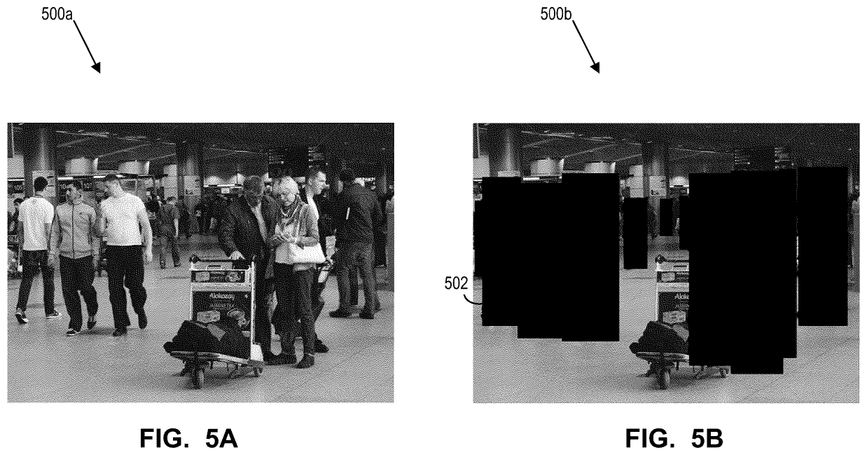

The redaction unit 306 may then receive the media elements from the identification unit 304, as well as the indications of the target redactions areas, and may apply redaction to those designated areas to generate the redacted media element. For example, this may include applying a blur, mask, remove, ghost, or cover to the target redaction areas. FIG. 5A shows an exemplary image 500a before redaction in accordance with an example embodiment. The image 500a contains unredacted data, for example, of people and potential identifying information. FIG. 5B shows an exemplary image 500b after redaction, and includes the redacted data 502. In this embodiment, the redaction rule used to identify the target redaction image areas is the presence of “people”, or human subjects.

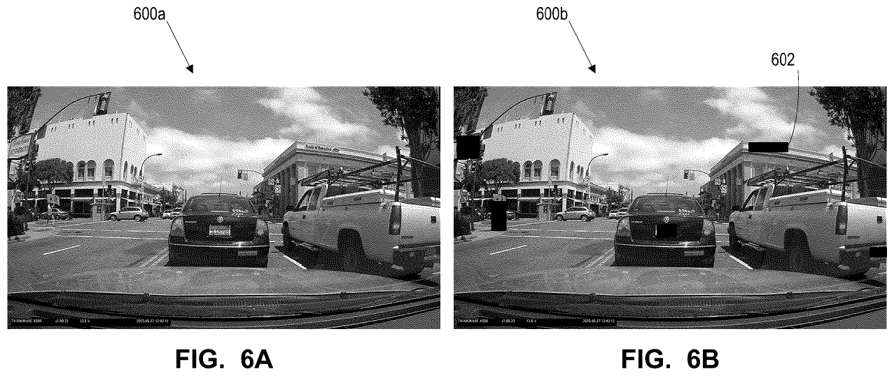

FIG. 6A shows another exemplary image 600a before redaction. The image 600a contains unredacted data, for example, of people and potential identifying information (e.g., license plate numbers and address information). FIG. 6B shows an exemplary image 600b after redaction. The image 600b contains redacted data 602. In this example embodiment, the redaction rules used to identify image areas that require redaction may include “license plates”, “home addresses”, “people” and “text”.

Referring now to FIG. 3B, there is shown a simplified block diagram for an example embodiment of a privacy redaction process 300b in accordance with some other embodiments.

The process 300b is generally analogous to the process 300a of FIG. 3A, with the exception that the privacy redaction module 104 has an added metadata extraction functionality using a metadata extraction unit 312.

The metadata extraction unit 312 is operable to extract derived metadata corresponding to one or more identified target redaction area, prior to the area being redacted. That is, once the target redaction area is indicated by the identification unit 304, the metadata extraction unit 312 may extract specific pre-defined features from that area which define the derived metadata. In some cases, the metadata extraction unit 312 can operate on the media element prior to the redaction unit 306. In other cases, the metadata extraction unit 312 can operate on the media element (or a copy thereof) concurrently or partially concurrently with the redaction unit 306.

The derived metadata, generated by the metadata extraction unit 312, can include various identifying information about the target redaction area. For example, where the target redaction area corresponds to a human subject, the derived metadata can include information about the subject's sex, height, body type, hair color, skin color, eye color, color of clothing, color composition related to the subject, etc. In other cases, where the target redaction area corresponds to a license plate, the derived metadata can include information, for example, about the geographic area tied to the license plate (such as the state or province), the license plate number itself etc. Accordingly, the derived metadata can correspond to any desirable extractable information based on one or more features, properties or characteristics of the target redaction area. As explained, the derived metadata can provide important information for third parties observing and analyzing the redacted images.

In various cases, the derived metadata, extracted from a given target redaction area, may vary based on the subject matter being redacted. For example, if the redacted area corresponds to a human face, the corresponding derived metadata may include analyzing the subject's sex, skin color, eye color or hair color etc. In another example, the derived metadata for a license plate can be, as previously discussed, the license plate number and the geographic area of the license plate (such as the state or province). Accordingly, there may be pre-defined metadata extraction rules for extracting derived metadata based on the subject matter being identified for redaction. In some cases, the pre-defined metadata extraction rules may correspond to the redaction rule applied. For example, if the redaction rule is redacting a human face, then the extraction unit 312 may automatically extract certain metadata associated with human faces. In such cases, the extraction rules may be the same as the redaction rules. In other cases, the extraction rules may not be the same as the redaction rules. For example, while the redaction rule may simply specify redacting any human face, the metadata extraction rules may specify that if the human face is determined to be a male then a first set of metadata is extracted, otherwise if the human face is determined to correspond to a female, then a second set of metadata is extracted. Accordingly, in some cases, the metadata extraction rules may depend on previously extracted metadata (e.g., the extracted human subject's perceived sex). The metadata extraction rules may also vary based on various external parameters, such as the environment, time of day, location of the edge device, etc.

In various cases, the metadata extraction unit 312 may also operate a trained machine learning module (i.e., a CNN) that is operable to analyze media elements and extract relevant metadata.

Similar to the redaction rules and redaction settings, the metadata extraction rules can be varied, directly or indirectly, by an operator interacting with the edge device 110. Similarly, different media recording units 102 may be associated with different derived metadata profiles, or otherwise different profiles for the type of derived metadata generated.

In the illustrated embodiment of FIG. 3B, after the redaction has occurred, the privacy redaction module 104 may generate two streams of data corresponding to the redacted media element 308 and the derived metadata 310. In some embodiments, the two streams may be transmitted through a single transport stream (i.e., a single multiplexed data stream). In other embodiments, the two streams may be transmitted through separate transport streams.

In some cases, the two streams can be identified as corresponding to one another by pixel location, pixel count, pixel coordinates, location of redacted object, or any other method of identifying corresponding redacted media element 308 with derived metadata 310.

Referring now to FIG. 3C, which shows a simplified block diagram for an example embodiment of a privacy redaction process 300c in accordance with one or more embodiments.

The process 300c is generally analogous to the process 300b with the exception that the privacy redaction module 104 does not generate a separate redacted media element and derived metadata streams, but rather embeds at least a portion of the derived metadata into the redacted media element. In some cases, the derived metadata is embedded in a free space around the redacted media element frame to generate a derived redacted media element 316. In some other cases, the derived metadata is overlaid (completely or partially) on the redacted media element frame to generate a derived redacted media element 316. In some further cases, the derived metadata is embedded directly in-line with the redacted media element frame to generate a derived redacted media element 316.

By embedding and/or encoding the derived metadata directly into the redacted media element or in the free space around the redacted media element, a reduced risk is present that the derived metadata will be lost during, for example, transmission, as the case may be where the derived metadata is transmitted in a separate stream. Further, there is a reduced risk that the derived metadata may be disassociated from its corresponding media element. That is, in cases where a plurality of derived metadata is sent separately from a plurality of redacted media elements, there may be problems in locating the corresponding derived metadata for each redacted media element. In still other cases, there are reduced issues involving synchronizing the derived metadata with corresponding redacted media elements (i.e., using timestamp data), as the derived metadata is embedded directly into the redacted media elements or in the free space around the redacted media element. In some cases, transmitted the redacted media elements and the derived metadata as two separate streams may be more resource intensive. For example, additional information may need to be stored in the derived metadata to enable correlation with the redacted media elements at a future time.

As shown, a media embedding unit 314 may be provided in the privacy redaction module 104 to embed and/or encode the derived metadata (e.g., from the metadata extraction unit 312) into the redacted media element (e.g., generated by the redaction unit 306).

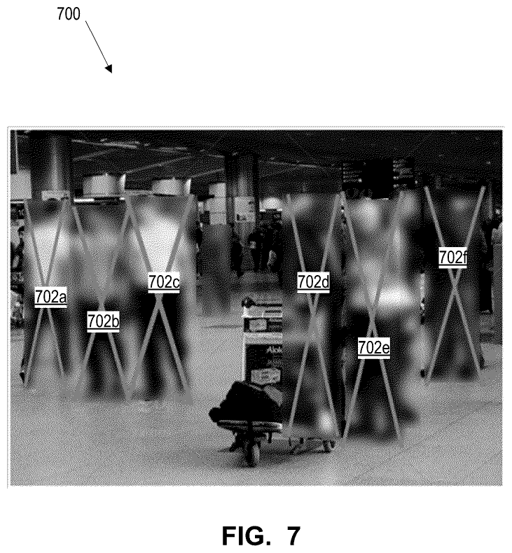

FIG. 7 shows an exemplary derived redacted media element 700 in accordance with one or more embodiments. In this example embodiment, the derived metadata may be embedded into the redacted media element to create the derived redacted media element 700. Further, in the illustrated example embodiment, the redaction areas of the image correspond to human subjects, and the derived metadata corresponds, for example, to the height and width of each subject, as well as to the subject's sex and the subject's center position in the image. As shown, the derived metadata is embedded into each redacted image area 702a-702f by a visual indicia that is located (e.g., overlaid) on the redacted area position. The derived metadata is encoded into various variable or adjustable properties of the visual indicia.

In the example embodiment of FIG. 7, an “X” mark is used as the visual indicia to encode and embed the derived metadata directly into the media element. For example, the location of the “X” can indicate the location of the pixel coordinates of the redacted subject in the image. In some cases, the point where the “X” crosses can indicate a center point location for the subject. Further, the height of the “X” mark (i.e., extending from the top to the bottom of the redacted area) can express the height of the subject, and similarly the width of the “X” mark can express the width of the subject. In some cases, different colors of markings can also be used to express different information (i.e., a blue “X” can indicate a male, while a pink “X” can indicate a female).

The derived metadata can also be expressed by adjusting other properties of the visual indicia including, for example, the type of line used (e.g., a choice of a stippled, solid or dotted lines for the “X” mark can indicate one or more of the sex, age, race etc. of the redacted subject) and the width of the line used (e.g., graded degrees of line thickness can indicate the size etc. of the human subject). Accordingly, each new adjustable variable in the visual indicia adds a new degree or dimension for information encoding. In some cases, different portions of the same visual indicia may also have adjustable properties, which further increases the constellation of data that can be encoded. For example, the top half of the “X” may have a thicker or thinner line width than the bottom half of the “X”, or the top half of the “X” may have a different line type (e.g., stippled, solid or dotted).

The actual shape of the visual indicia may be another adjustable property. For instance, varying the shape properties of the visual indicia can, itself, encode different types of metadata (e.g., a circle may denote a child, while a triangle can denote an adult, etc.)

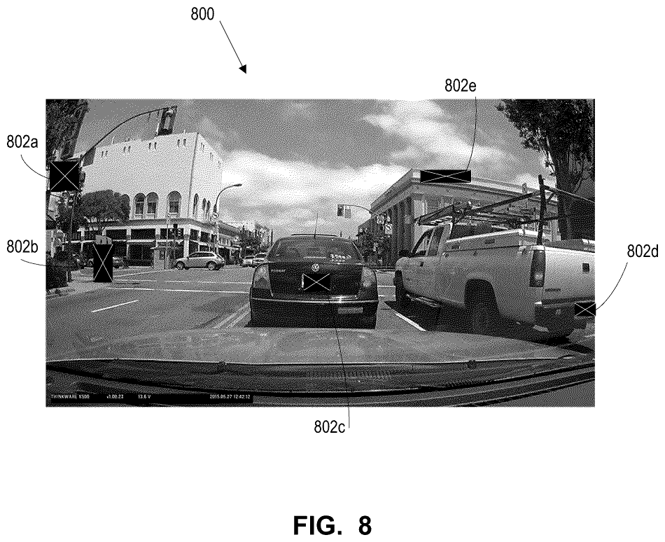

FIG. 8 shows another example embodiment where a visual indicia is used to embed the derived metadata into the redacted media element to generate the derived media element 800. As shown, each redacted object 802a-802e is marked with an “X” to indicate a position and/or size of the redacted image area.

In still other embodiments, the visual indicia's may not be shapes, but can be any other suitable indicia such as a barcode, a QR code, various shape patterns, color grid encoding, text (i.e., plain text expressing the metadata or coded/crypted text (e.g., hashes, alphanumeric codes, etc.)).

In some embodiment, the derived metadata can also be encoded by varying the type of redaction method used (e.g., the type of blur, cover or mask can be selected to encode certain data). In some cases, the size of the redaction area may, itself, encode metadata. For example, the height and/or width of the redacted area can indicate the height and width of the subject. In various cases, non-visual indicia (i.e., watermarks) can also be used to embed and encode data

Once the derived redacted media element is received at a computer device 108 (or server 204), the computer device 108 (or server 204) may include the decoding module 230 that stores the pre-configured decoding rules in order to extract and decode metadata from each received derived redacted media element.

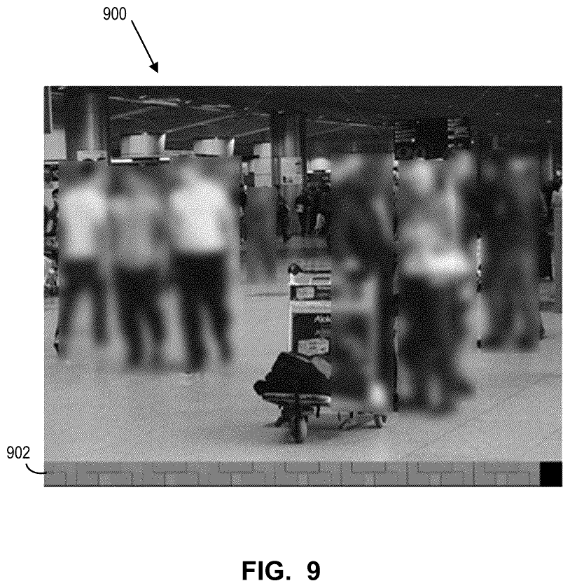

Referring next to FIG. 9 there is shown an exemplary derived redacted media element 900 in accordance with some other embodiments.

The derived media element 900 is generally analogous to the derived redacted media element 700, with the exception that the indicia 902 used to encode the metadata may not be directly overlaid (completely or partially) over the redacted areas. For example, an augmented redacted media element 900 can be generated, whereby additional area is inserted around one or more edges (or portions of edges) of the redacted media element, and the indicia can be inserted in the surplus area. In other cases, the redacted media element can be cropped and the indicia can be inserted in the additional area resulting from the cropping. In other cases, the indicia 902 can be directly overlaid (completely or partially) over the media element, but not directly overlaid over the redacted areas. In some further cases, the indica 902 can be embedded anywhere in the media element where there is free space.

In some cases, each discrete indicia included in the derived redacted media element 900 can correspond to a specific redacted area (i.e., a one-to-one mapping). In these cases, each indicia may also encode information about which redaction target area it corresponds to. For example, each indicia can include one or more pixel coordinate information about the location of the target area that is associated with that marking (e.g., coordinates of the center point of the redacted area, or coordinates of one or more corners of the redacted area). In this manner, a decoding module 230 can associate different indicia 902 with different associated redacted areas.

In some cases, a single indicia can also correspond to more than one redaction area, and may include encoded information about which redaction areas it corresponds to. For example, multiple redaction areas may have similar derived metadata, which can be encoded using a single indicia. The indicia can include the common derived metadata between each target area, as well as identifying information about which target areas are associated with this common derived metadata.

In some cases, multiple indicia can correspond to the same redaction area, and may include encoded information about which redaction areas it corresponds to. For example, the same redaction area may have multiple metadata points, such as data corresponding to height and color composition, which can be encoded using multiple indicia. The indicia can include the derived metadata as well as identifying information about which target areas are associated with this derived metadata.

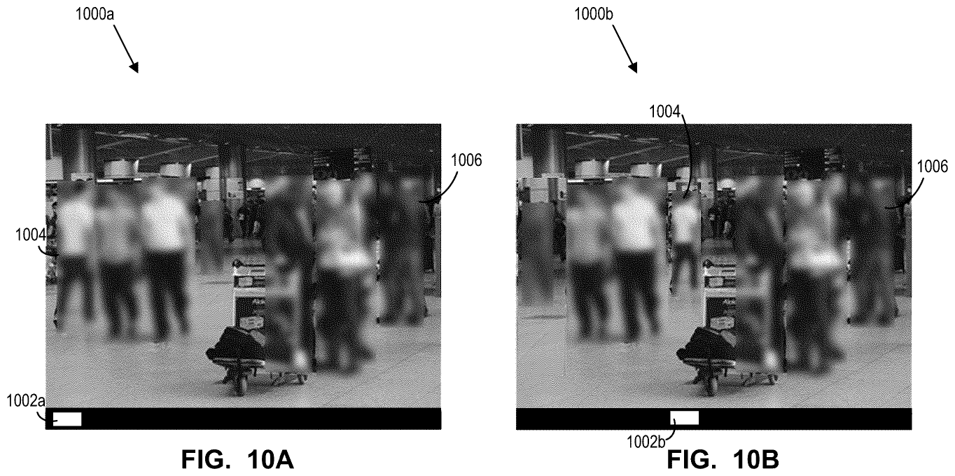

FIGS. 10A and 10B show other example embodiments where the indicia 1002 used to encode the metadata is not directly overlaid over the redacted areas in the generation of derived media elements 1000a and 1000b, respectively. The derived media elements 1000a and 1000b are generally analogous to the derived media element 900. In the example shown, FIG. 10A is a frame recorded prior to the frame recorded in FIG. 10B.

In some cases, tagged indicia 1002a and 1002b can correspond to a particular subject 1004 for tracking purposes. In these cases, a particular subject 1004 can be tagged by the edge device 110 and can be monitored as the subject 1004 moves from frame to frame. The indicia 1002a and 1002b can encode information such as skin color, hair color, eye color, clothing color, or color composition of the subject 1004 as well as target information about which redaction target area it corresponds to. For example, each indicia can include one or more pixel coordinate information about the location of the subject 1004 and the color composition of the subject 1004. Color composition can be a gradient taken from hair color, skin color, clothing color and shoe color to identify the subject as they move across multiple frames. In some cases, pixel location of the subject 1004 can be identified and compared between frames to determine location of the subject 1004. In some cases, depth tracking can be used for assistance in location determination. For example, subject 1004 is located on the left side of the frame and corresponding to indicia 1002a in FIG. 10A. FIG. 10B shows the subject 1004 within the center of the frame corresponding to indicia 1002b. Subject 1004 can be identified across multiple fames by the edge device processor 202 based on the color composition. The subject 1004 can be tracked over multiple frames taken by the media recording unit 102 at the edge device 110.

In some cases, other factors may be relied upon for tracking purposes. For example, the subject's clothing or a particular piece of clothing, the number of visible suitcases associated with them, the height and width of the subject etc. can be used to identify and track subjects.

Tracking features can be used to determine traffic flow patterns at traffic lights, pedestrian crossing usage, data collection at airports (e.g. determining how many people are catching connecting flights vs. have reached their final destination), time spent by students at their lockers in schools, etc. In some cases, multiple objects and/or subject can be tagged and tracked at the same time in the same frames.

Tracking can be done in real-time or near real-time as well as by post processing not in real-time. In some cases, multiple objects and/or subjects identified in frames of the derived media elements may be tracked using previously recorded frames. In some cases, previously derived metadata from the media elements can be used to determine movements of objects and/or subjects detected. For example, previously recorded frames of media elements having derived metadata can be processed to determine if multiple recorded indicia correspond to the same object (e.g., identical metadata on color composition, etc.) across multiple frames. The object can then be tracked using metadata embedded within the free space around the redacted media element.

In some cases, indicia 1002 can be used for counting purposes. As discussed above in relation to tracking, color composition of objects can be used to determine the number of objects within a frame. For example, the color composition of object 1004 may be different than the color composition of object 1006. Object 1004 and object 1006 can be counted as separate objects based on the color composition. Color composition can be used to prevent counting an object twice in the same frame or media segment. In some cases, facial detection can be used to count individual people within a frame.

In some cases, the ability to integrate the counting of objects with object tracking can be beneficial. For example, in an airport, data can be collected based on how many people are leaving a first airport gate and moving to a second airport gate for a connecting flight. The number of individuals leaving the first airport gate can be noted, and each individual can be tracked to determine if they have moved from the first airport gate to the second airport gate. This can show how many individuals have actually entered the second airport gate from the first airport gate, as opposed to taking a general number of individuals entering the second airport gate, which would not provide a data point on how many individuals have taken a connecting flight.

Use cases for the edge device 100 may include using the device in washrooms, schools, airports, restaurants, sports venues, shops, recreational facilities, or any other establishment. Further use cases may include monitoring roadways, traffic stops, crosswalks, parking lots, etc. In such use cases, privacy is of importance to individuals. The edge device 100 provides a way to protect the privacy of individuals as the raw media does not leave the edge device 100. The media can be examined, metadata can be derived, certain elements in the media can be redacted and metadata can be embedded within the redacted media prior to the media leaving the edge device 100.

For example, municipalities can use employees to monitor the use of traffic lights by counting, tracking and collecting data on vehicles, right vs. left turns, pedestrians using the crosswalks, etc. The use of an employee is time consuming, expensive, and the data is subject to human error. The use of the edge device 100 to track and count would reduce the cost, employee time and error margins while still maintaining the privacy of subjects recorded by the media recording unit 102.

In another example, work locations (e.g., mines, yards, etc.) can use the edge device 100 to track and count trucks and/or other vehicles entering or exiting the work location. For example, loads taken from or brought to the work location by the trucks can be monitored, the number of trucks can be counted, etc., while protecting the privacy of the individuals driving. The license plates of the trucks as well as individual faces of the drivers can be redacted to protect individual privacy.

The present application can allow monitoring and extraction of data based on individuals without compromising on individual privacy. The ability to track and count subjects, objects or vehicles for statistical purposes while maintaining individual privacy is important on institutional and personal levels.

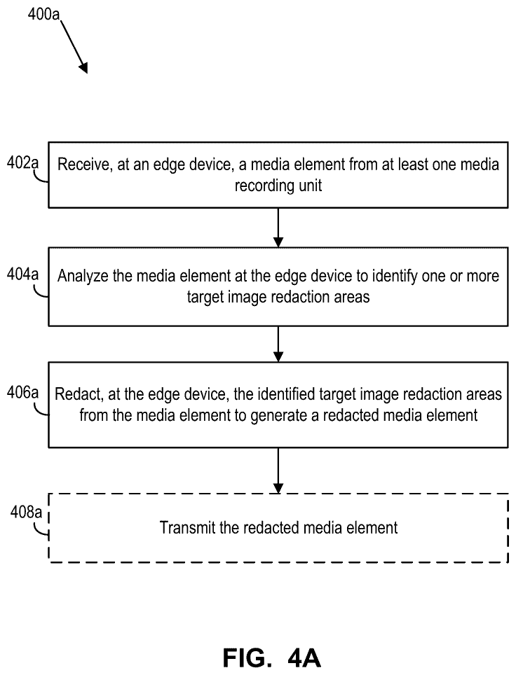

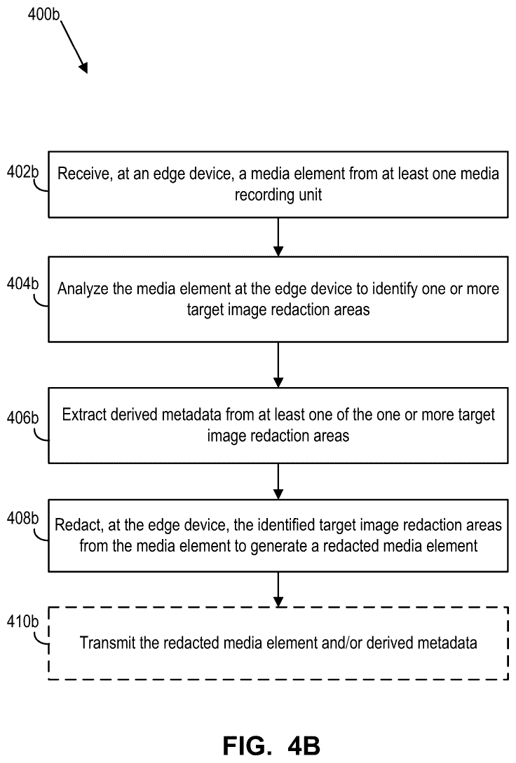

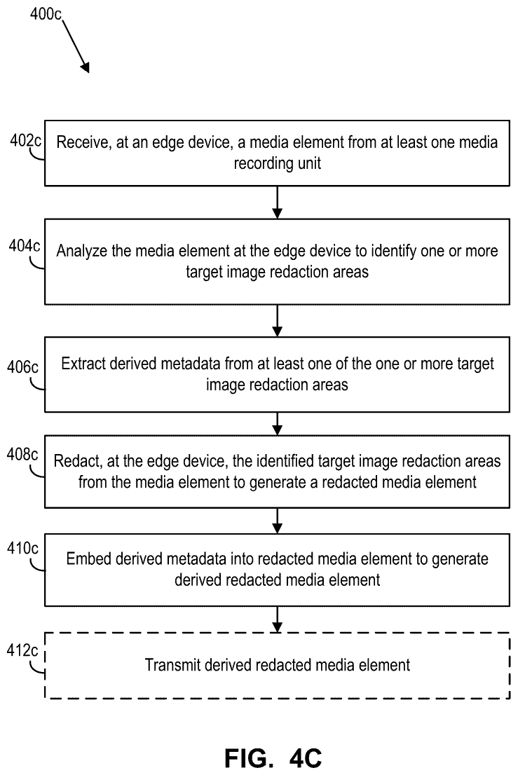

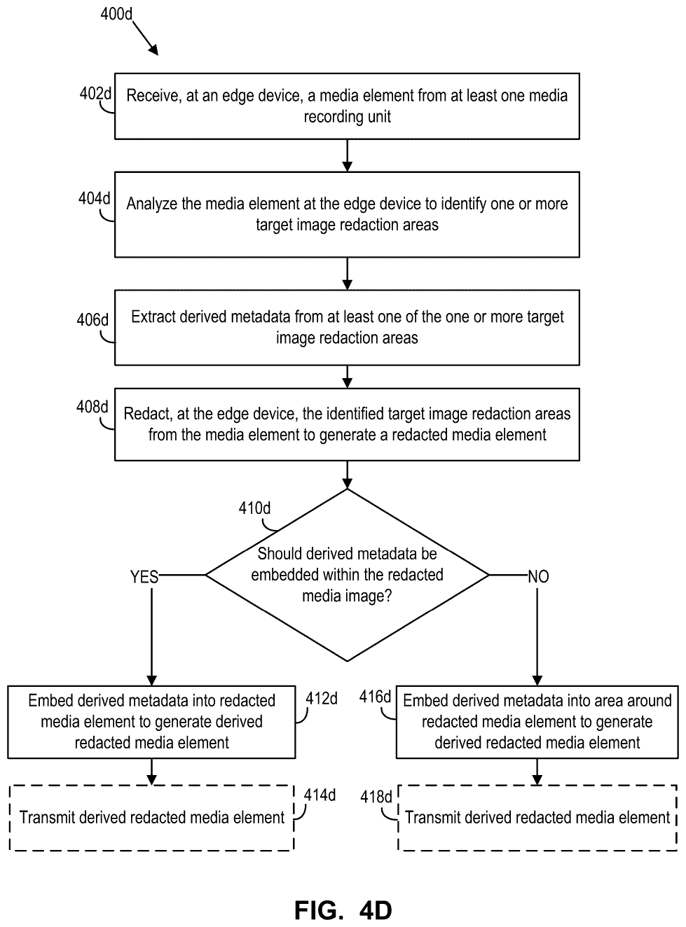

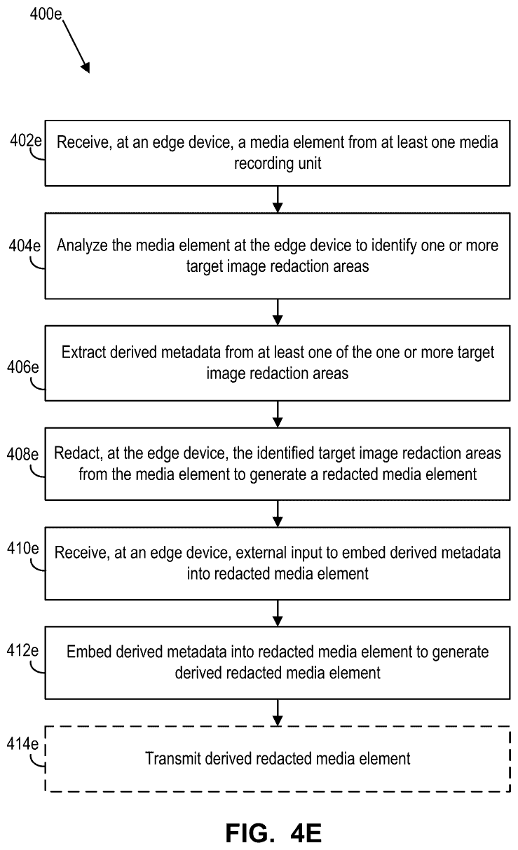

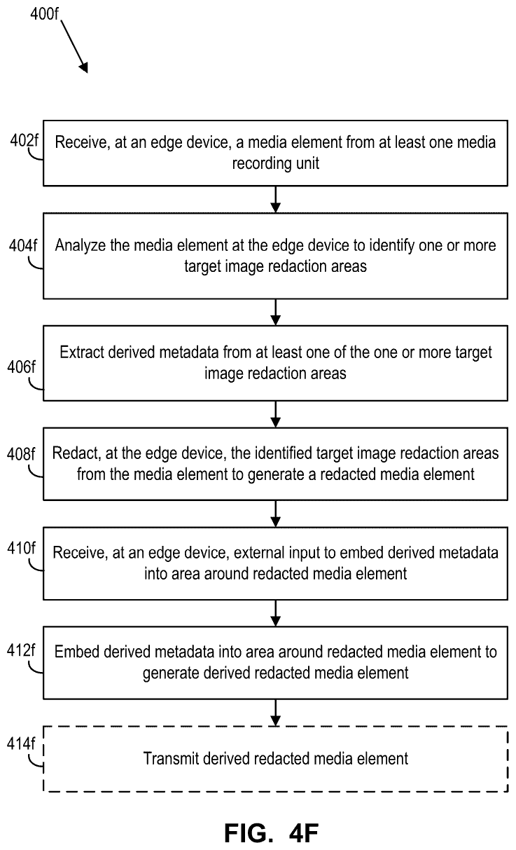

Reference is now made to FIG. 4A, which shows an example embodiment of a method 400a for redacting media elements at an edge device. Method 400a can be performed, for example, by the processor 202 of the edge device 110.

At 402a, a media element is received from a media recording unit 102 by the edge device processor 202. The media element may be, for example, a video comprising multiple video frames, where each frame requires redaction of identified areas. In other embodiments, the media element may be an image.

At 404a, the media element is analyzed in real-time or near real-time by the edge device processor 202 (i.e., executing the privacy redaction module 104) to identify any areas of the media element require redaction (i.e., target redaction areas). In other cases, the media element is not necessarily analyzed in real-time or near real-time, but rather is stored on the memory 210 and may be retrieved for subsequent analysis. As discussed, the target redaction areas may be identified based on one or more redaction rules and/or redaction settings. The target redaction areas can be identified, as also discussed, by using one or more indicators (i.e., pixel coordinates) of the areas requiring redaction.

At 406a, the identified target redaction area or areas are redacted from the media element to generate a redacted media element. In some cases, the redaction occurs in real-time or near real-time. In other cases, the redaction can occur on a previously stored media element (i.e., stored on the edge device memory 210).

At 408a, in some embodiments, the redacted media element may be transmitted, for example, to one or more computer devices 108 via network 105.

Reference is now made to FIG. 4B, which shows an example embodiment of a method 400b for redacting media elements at an edge device 110. Method 400b can be performed, for example, by the processor 202 of the edge device 110.

Method 400b is generally analogous to method 400a, with the exception that after identifying the target image redaction areas at act 404b, at 406b, the privacy redaction module 104 can extract derived metadata from one or more of the areas identified as target redaction areas. At 408b, the target image redaction areas can then be redacted. At 410b, the redacted media element and the derived metadata may be separately transmitted.

Reference is now made to FIG. 4C, there is shown an example embodiment of a method 400c for redacting media elements at an edge device. Method 400c can be performed, for example, by the processor 202 of the edge device 110.

Method 400c is generally analogous to method 400b, with the exception that at act 410c, one or more derived metadata can be embedded and/or encoded into the redacted media element to generate a derived redacted media element. At act 412c, the derived redacted media element may be transmitted.

Reference is now made to FIG. 4D, there is shown an example embodiment of a method 400d for redacting media elements at an edge device. Method 400d can be performed, for example, by the processor 202 of the edge device 110.

Method 400d is generally analogous to method 400c, with the exception that at act 410d, the processor 202 can make a decision on the location where the metadata can be embedded to generate a derived redacted media element.

In some cases, the decision at act 410d can be made based on pre-programmed conditions. The pre-programmed conditions can be selected by a user, based on location, for particular projects, based on the number of redacted items, etc. For example, if the edge device 110 is located at a traffic light, the pre-programmed condition can be directed to act 412d. At 412d, one or more derived metadata can be embedded and/or encoded into the redacted media element to generate a derived redacted media element, as shown in FIG. 7, for example. The pre-programmed condition at a traffic light may embed the derived metadata within the redacted media element as the number of subjects at a traffic light can be lower than the number of subjects at, for example, an airport. The reduced number of subjects results in a derived redacted media element that contains the derived metadata in the media element without being overcrowded. At act 414d, the derived redacted media element may be transmitted.

In another example, if the edge device 110 is located in an airport, the pre-programmed condition can be direction to act 416d. At 416d, one or more derived metadata can be embedded and/or encoded into area around the redacted media element to generate derived redacted media element, as shown in FIG. 9, for example. The pre-programmed condition at an airport may embed the derived metadata into the area surrounding the redacted media element as the number of subjects can be a lot higher. In such instances, having the metadata embedded within the media element can result in a crowded frame and as such, embedding the metadata around the media element results in increased readability. At act 418d, the derived redacted media element may be transmitted.

In some cases, the decision at act 410d can be made based on dynamic pre-programmed conditions. The dynamic pre-programed conditions can change based on the metadata derived from the at least one or more target image redaction areas. For example, the edge device 110 may be initially pre-programmed to embed the derived metadata into the redacted media image at act 412d when being used to count individuals. Once a certain number of individuals have been counted, the edge device 110 may change pre-programmed conditions to embed the derived metadata into the area around the redacted media image at act 416d.

Reference is now made to FIG. 4E, there is shown an example embodiment of a method 400e for redacting media elements at an edge device. Method 400e can be performed, for example, by the processor 202 of the edge device 110.

Method 400e is generally analogous to method 400c, with the exception that at act 410e, external input can be received at the communication interface 204 of the edge device 110 to embed derived metadata into the redacted media element. At act 412e, one or more derived metadata can be embedded and/or encoded into the redacted media element to generate a derived redacted media element. In some cases, the metadata can be embedded by way of an overlaid layer, where the overlay may be partial or complete. In some cases, the metadata can be embedded in the same layer as the redacted image. At act 414e, the derived redacted media element may be transmitted.

Reference is now made to FIG. 4F, there is shown an example embodiment of a method 400f for redacting media elements at an edge device. Method 400f can be performed, for example, by the processor 202 of the edge device 110.

Method 400f is generally analogous to method 400e, with the exception that at act 410f, external input can be received at the communication interface 204 of the edge device 110 to embed derived metadata into the area around the redacted media element. At act 412f, one or more derived metadata can be embedded and/or encoded into the area around the redacted media element to generate a derived redacted media element. At act 414f, the derived redacted media element may be transmitted.

The external input may be from a user or an operator of the edge device. In some cases, a prompt may be provided to the user to select where the derived metadata may be input in relation to the redacted media element. In some cases, the prompt may be triggered by a pre-determined time. In some cases, the prompt may be triggered based on metadata collected from the redacted media element. For example, if the metadata collected includes the count of the number of people within the frame, once the count reaches 50, the prompt may be triggered. In some cases, the prompt may be triggered by a user configuration instruction.

The present invention has been described here by way of example only. Various modifications and variations may be made to these exemplary embodiments without departing from the spirit and scope of the invention, which is limited only by the appended claims.

We claim:

1. A redaction system, the system comprising:
an edge device comprising at least one media recording unit and a processor;
the at least one media recording unit being configured to record media elements, and
the processor being configured to:
receive a media element from the at least one media recording unit;
analyze the media element to identify one or more areas requiring redaction, wherein the areas requiring redaction are identified based on one or more redaction rules; and
redact the identified areas from the media element to generate a redacted media element comprising one or more redacted areas.

2. The system of claim 1, wherein the processor is further configured to extract metadata from the determined areas prior to redaction to generate derived metadata, the derived metadata comprising informational data about the redacted areas.

3. The system of claim 2, wherein the processor is further configured to, after redaction, embed the derived metadata into the corresponding media element to generate a derived redacted media element.

4. The system of claim 1, wherein the processor is further configured to transmit the redacted media element to an external device.

5. The system of claim 2, wherein the processor is further configured to transmit the redacted media element and the derived metadata through separate transport streams.

6. The system of claim 3, wherein the processor is further configured to transmit the derived redacted media element.

7. The system of claim 1, wherein the processor is configured to use an artificial intelligence algorithm to identify the image areas requiring redaction.

8. The system of claim 1, wherein the redaction rules are comprised of inputs from an operator.

9. The system of claim 1, wherein the redaction rules comprises determine the presence in the media element of one or more of human faces, license plate numbers, home addresses.

10. A redaction system, the system comprising:
at least one media recording unit for recording one or more media elements;
at least one redaction device, the at least one redaction device being connected to the at least one media recording unit, the at least one redaction device comprising a processor and a memory unit, the processor being configured to:
receive a media element from the at least one media recording unit;
analyze the media element to identify one or more areas requiring redaction wherein the areas requiring redaction are identified based on one or more redaction rules; and
redact the identified image areas from the media element to generate a redacted media element with redacted areas.

11. The system of claim 10, wherein the processor is further configured to extract metadata from the identified image areas prior to redaction to generate derived metadata, the metadata comprising informational data based on the redacted areas.

12. The system of claim 11, wherein the processor is further configured to, after redaction, embed at least a part of the derived metadata into the corresponding redacted media element to generate a derived redacted media element.

13. The system of claim 10, wherein the processor is further configured to transmit the redacted media element.

14. The system of claim 11, wherein the processor is further configured to transmit the redacted media element and the derived metadata through separate transport streams.

15. The system of claim 11, wherein the processor is further configured to transmit the derived redacted media element.

16. The system of claim 10, wherein the processor uses an artificial intelligence algorithm to identify the areas of the media element requiring redaction.

17. The system of claim 10, wherein the redaction rules are comprised of inputs from an operator.

18. The system of claim 10, wherein the processor is coupled to a memory unit.

19. The system of claim 18, wherein the memory unit is configured to store the redacted media element, the metadata, and the derived redacted media element.

20. The system of claim 10, wherein the redaction rules comprises determine the presence in the media element of one or more of human faces, license plate numbers, home addresses.
